(19) United States
(12) Patent Application Publication
(10) Pub. No.: US 2015/0365651 A1
(43) Pub. Date: Dec. 17, 2015

(54) SYSTEM FOR DETERMINING A THREE-DIMENSIONAL IMAGE OF AN ELECTRONIC CIRCUIT

(71) Applicant: VIT, Saint Egreve (FR)

(72) Inventors: Mathieu PERRIOLLAT, Saint Egreve (FR); Pierre SCHROEDER, Fontaine (FR)

(21) Appl. No.: 14/763,865

(22) PCT Filed: Jan. 30, 2014
(86) PCT No.: PCT/FR2014/050168

§ 371 Date: Jul. 28, 2015

(30) Foreign Application Priority Data
Jan. 31, 2013 (FR) 1350813

(51) Int. Cl. H04N 13/02; G01B 11/25; G06T 7/20; G06T 7/00

(52) U.S. Cl. CPC H04N 13/0239; G06T 7/0004; G01B 11/254; G06T 7/20; H04N 2013/0081

(57) ABSTRACT

A method for determining three-dimensional images of an object (Card) comprises projecting a display onto the object by means of a projector (P). A plurality of two-dimensional images of the object are acquired by at least one first image sensor (C), a relative movement of the object in relation to the assembly comprising the projector and the image sensor being carried out during the acquisitions of the images. A determination is made of the height of each point of the object as corresponding to an extremum of a function obtained from the acquired two-dimensional images.

The present patent application claims the priority benefit of French patent application FR13/50813 which is herein incorporated by reference.

### BACKGROUND

The present disclosure generally relates to optical inspection systems and, more specifically, to three-dimensional image determination systems intended for the on-line analysis of objects, particularly of electronic circuits. The present invention more specifically relates to systems fitted with digital cameras.

### DISCUSSION OF THE RELATED ART

A system for optically inspecting an object, for example, an electronic circuit, generally comprises a device for projecting specific patterns onto the circuit to be inspected and at least one digital camera capable of acquiring a plurality of images of the circuit. The projected image comprises, for example, a succession of bright and dark fringes.

An example of a three-dimensional image determination method comprises projecting a plurality of images onto the circuit to be inspected. It may for example be images comprising repeated patterns. It may also be a random image. The images projected during two successive projections differ from each other. For example, when the image comprises patterns, said patterns may be shifted from one projected image to the other. An image of the circuit is acquired for each new position of the image projected onto the circuit.

A three-dimensional image may be determined from the images of the circuit acquired by the digital camera.

### SUMMARY

Thus, an embodiment provides a method of determining three-dimensional images of an object, comprising projecting a display onto the object with a projector; acquiring a plurality of two-dimensional images of the object with at least one first image sensor, a relative displacement of the object with respect to the assembly comprising the projector and the image sensor being performed during the image acquisitions; and determining the height of each point of the object as corresponding to an extremum of a function obtained from the acquired two-dimensional images.

According to an embodiment, the projector and/or the first image sensor are of perspective type.

According to an embodiment, the projected display is identical on acquisition of each two-dimensional image.

According to an embodiment, the display comprises fringes.

According to an embodiment, a relative displacement of the object with respect to the assembly comprising the projector and the image sensor is performed on acquisition of at least one of the two-dimensional images.

According to an embodiment, a relative displacement of the object with respect to the assembly comprising the projector and the image sensor is performed on acquisition of each two-dimensional image.

According to an embodiment, the relative displacement is accelerated between the acquisitions of the two images of at least one pair of successive two-dimensional images.

According to an embodiment, the relative displacement speed is constant to within 10%.

According to an embodiment, the method comprises acquiring a plurality of two-dimensional images of the object with at least one second image sensor, the height of each point of the object corresponding to an extremum of a function obtained from the images acquired by the first and second image sensors.

An embodiment also provides a system for determining three-dimensional images of an object, comprising:

a projector capable of projecting a display onto the object;

a first image sensor capable of acquiring a plurality of two-dimensional images of the object;

a conveyor capable of displacing the object with respect to the assembly comprising the projector and the first image sensor on successive acquisitions of two-dimensional images; and

processing means capable of determining the height of each point of the object as corresponding to an extremum of a function obtained from the acquired bidimensional images.

According to an embodiment, the projector and/or the image sensor are of perspective type.

### BRIEF DESCRIPTION OF THE DRAWINGS

The foregoing and other features and advantages will be discussed in detail in the following non-limiting description of specific embodiments in connection with the accompanying drawings, among which:

FIG. 1 schematically shows an embodiment of a system of optical inspection of electronic circuits;

FIG. 2 shows a curve of the variation of the displacement over time of a circuit to be inspected for a conventional optical inspection system;

FIGS. 3 and 4 show curves of the variation of the displacement over time of a circuit to be inspected for two embodiments of optical inspection systems;

FIG. 5 schematically illustrates an example of a three-dimensional image determination method;

FIGS. 6 and 7 schematically illustrate other examples of a three-dimensional image determination method;

FIG. 8 schematically illustrates an embodiment of a three-dimensional image determination method; and

FIG. 9 schematically shows another embodiment of a system of optical inspection of electronic circuits.

For clarity, the same elements have been designated with the same reference numerals in the different drawings.

### DETAILED DESCRIPTION

For clarity, the same elements have been designated with the same reference numerals in the various drawings and, further, the various drawings are not to scale. In the following description, unless otherwise indicated, terms “substantially”, “approximately”, and “in the order of” mean “to within 10%”. Further, only those elements which are useful to the understanding of the present description have been shown and will be described. In particular, the means for controlling the conveyor of the optical inspection system described hereafter are within the abilities of those skilled in the art and are not described.

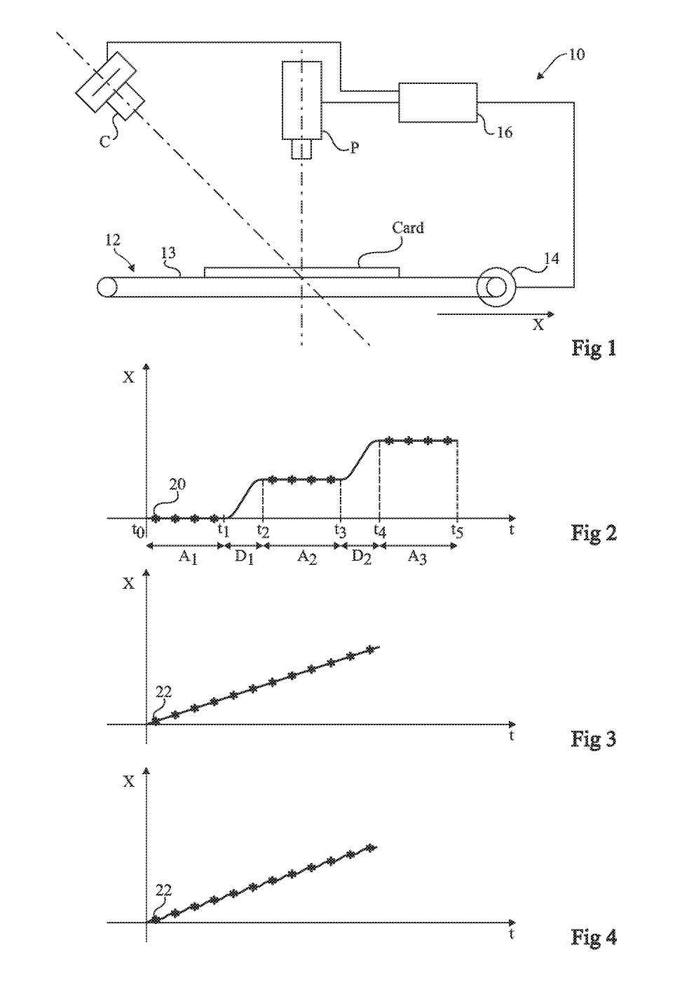

FIG. 1 very schematically shows an electronic circuit inspection system 10. Term electronic circuits indifferently designates an assembly of electronic components interconnected via a support, the support alone used to form this interconnection without the electronic components or the support without the electronic components but provided with means for attaching the electronic components. As an example, the support is a printed circuit and the electronic components which are attached to the printed circuit by paste bumps which, after heating, form welding joints. In this case, electronic circuit indifferently designates the printed circuit alone (with no electronic components or paste bumps), the printed circuit provided with the paste bumps and without electronic components, the printed circuit provided with the paste bumps and electronic components before the heating operation, or the printed circuit provided with the electronic components attached to the printed circuit by the welding joints.

System 10 enables to determine a three-dimensional image of electronic circuit Card. Each electronic circuit Card is placed on a conveyor 12, for example, a planar conveyor. Conveyor 12 is capable of displacing circuit Card along a direction X, for example, a horizontal direction. As an example, conveyor 12 may comprise an assembly of straps 13 and of rollers driven by a rotating electric motor 14. As a variation, conveyor 12 may comprise a linear motor displacing a carriage supporting electronic circuit Card.

System 10 comprises an image projection device P comprising at least one projector, a single projector P being shown in FIG. 1. Projector P is connected to an image processing computer system 16. When a plurality of projectors P are present, projectors P may be substantially aligned, preferably along a direction perpendicular to direction X. System 16 may comprise a microcontroller comprising a processor and a non-volatile memory having instructions stored therein, their execution by the processor enabling system 16 to performed desired functions. As a variation, system 16 may correspond to a dedicated electronic circuit. Electric motor 14 is further controlled by system 16.

System 10 further comprises an image acquisition device C comprising at least one digital camera, a single camera C being shown in FIG. 1. Camera C is connected to image processing computer system 16. When a plurality of cameras C are present, cameras may be substantially aligned, preferably along a direction perpendicular to direction X and/or may be arranged on either side of projector(s) P.

In the present embodiment, camera C and projector P are fixed and electronic circuit Card is displaced with respect to camera C and to projector P via conveyor 12. As a variation, electronic circuit Card is fixed and camera C and projector P are displaced with respect to electronic circuit Card by any adapted conveying device.

To simplify the following description, a single projector P and a single camera C are considered. Camera C is fixed with respect to projector P.

The dimensions of circuit Card, for example, corresponding to a card having a length and a width varying from 50 mm to 550 mm, are generally greater than the field of view of camera C so that circuit Card should be displaced with respect to projector P and to camera C in order for the entire surface area of circuit Card to be seen by camera C.

FIG. 2 shows a curve of the variation of the displacement of electronic circuit Card along direction X over time for an example of image acquisition method for the determination of a three-dimensional image. Times t₀ to t₅ are successive times. In FIG. 2, each star 20 shows the time of acquisition of an image by camera C.

An image acquisition phase A₁ is carried out between times t₀ and t₁. During phase A₁, circuit Card is motionless with respect to projector P and to camera C. The three-dimensional image of the portion of circuit Card seen by camera C is determined from a plurality of images acquired by camera C during phase A₁ while different images are projected onto circuit Card by projector P. Each projected image corresponds, for example, to fringes. The position of the projected fringes is shifted from one projected image to the other. A displacement phase D₁ is carried out between times t₁ and t₂, where circuit Card is displaced by conveyor 12 until another portion of the electronic circuit can be seen by camera C. An image acquisition phase A₂ is carried out between times t₂ and t₃ for the determination of a three-dimensional image of this other portion of circuit Card. A displacement phase D₂ is carried out between times t₃ and t₄, and an image acquisition phase A₃ is carried out between times t₄ and t₅. In the example illustrated in FIG. 2, four images are acquired by camera C during each acquisition phase A₁, A₂, A₃. However, this number may be variable. The duration of each acquisition phase A₁, A₂, A₃ particularly depends on the number of acquired images, where some of the acquired images may not be intended for the determination of a three-dimensional image. As an example, the duration of each acquisition phase A₁, A₂, A₃ is approximately 1.2 s in the case of the acquisition of 11 images and approximately 0.76 s in the case of the acquisition of 7 images and the duration of a displacement phase D₁, D₂ is approximately 0.35 s.

A disadvantage of the previously-described three-dimensional image determination method is that the total duration necessary to determine the three-dimensional image of the entire circuit Card, which is equal to the sum of the durations of image acquisition phases A₁, A₂, A₃ and of the directions of displacement phases D₁, D₂ of circuit Card, may be significant, particularly due to the time taken for the displacement of circuit Card during which no image acquisition is performed.

Further, during an image acquisition phase, the image projected by projector P onto circuit Card is modified between two acquisitions. Means for modifying the projected image should thus be provided, which may require using a projector P having a complex structure and/or adapting computer processing system 16.

Thus, an object of an embodiment is to overcome all or part of the disadvantages of methods of three-dimensional image determination by an optical inspection system.

Another object of an embodiment is to decrease the duration of an operation of determination of a three-dimensional image of the entire electronic circuit to be inspected.

Another object of an embodiment is to simplify the provision of the images projected by projector P.

Another object of an embodiment is to use projectors and/or cameras having a simple and low-cost optical system.

Another object of an embodiment is to provide a three-dimensional image determination system implying fast image processing operations, whatever the shape of the three-dimensional scene to be observed.

To achieve all or part of these and other objects, a system of optical inspection of electronic circuits is provided, wherein the electronic circuit to be inspected is no longer motionless during an image acquisition phase for the determination of a three-dimensional image but is displaced during a phase of image acquisition for the determination of a three-dimensional image.

Hereafter, an optical system having its main rays parallel in the object space is called telecentric optical system. The object space designates the scene (circuit Card) independently for the cameras and the projectors. An optical system which is not telecentric is called perspective optical system. According to an embodiment, at least one device from among projector P and camera C is of perspective type. This advantageously enables to decrease the bulk of the inspection system, given that image projection or acquisition devices of perspective type have a smaller bulk than analog devices of telecentric type. This further advantageously enables to decrease the cost of the inspection system, given that image projection or acquisition devices of perspective type have a lower cost than analog devices of telecentric type.

FIGS. 3 and 4 illustrate embodiments of methods of determining a three-dimensional image of the entire circuit Card. In FIGS. 3 and 4, each star 22 shows the time of acquisition of an image by camera C.

According to an embodiment, a relative displacement between circuit Card and the assembly comprising projector P and camera C is performed all along the three-dimensional image determination operation. For this purpose, circuit Card may be displaced by conveyor 12 during the image acquisition, projector P and camera C remaining fixed. As a variation, circuit Card may be fixed and the assembly comprising projector P and camera C is displaced during the image acquisition.

As an example, the duration between two successive image acquisitions is in the range from 10 ms to 250 ms. The duration between successive image acquisitions may be substantially constant to within 10%.

In the embodiment illustrated in FIG. 3, the relative displacement speed between circuit Card and the assembly comprising projector P and camera C is substantially constant to within 10%. The displacement speed particularly depends on the image projection method used. As an example, the displacement speed is in the range from 20 mm/s to 200 mm/s.

In the embodiment illustrated in FIG. 4, the relative displacement speed is temporarily increased, for example, by more than 30%, between two successive image acquisitions by the camera. Preferably, between two successive acquisitions of an image by camera C, the relative displacement speed is increased and then decreased so that the relative displacement speed at the time of the acquisition of an image is substantially the same for each image acquisition.

As an example, conveyor 12 is controlled by computer processing system 16 to control the displacement of circuit Card between two successive acquisitions. The acquired images are used to determine the three-dimensional image of the entire circuit Card. However, for the determination of the three-dimensional image of a portion only of circuit Card, only a few successively acquired images are used, preferably more than three images, for example, eight images.

According to an embodiment, the image projected by projector P onto circuit Card on acquisition of the images by camera C is identical for a plurality of successively-acquired images, preferably for all the successively-acquired images.

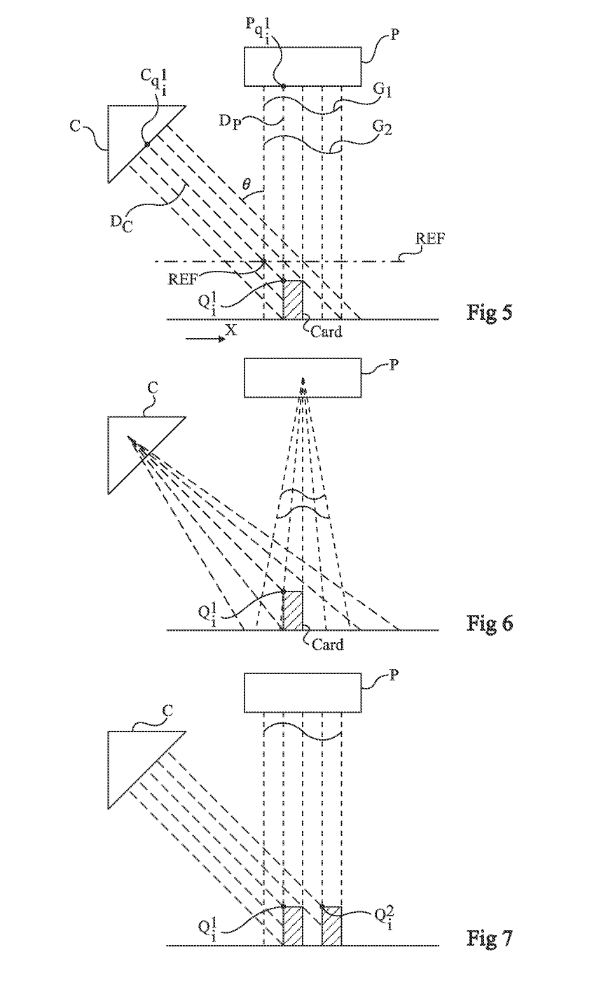

FIG. 5 illustrates an example of a method of determining a three-dimensional image in the case where circuit Card to be inspected is motionless with respect to projector P and to camera C on acquisition of a plurality of successive images. REF designates a reference plane, parallel to the plane supporting circuit Card. Lines D_{P} showing the path of rays projected by projector P and lines D_{C} showing the path of rays received by camera C have been shown in dotted lines.

Call R_{REF}(O, X, Y, Z) a reference frame linked to reference plane REF where direction X is the displacement direction of circuit Card, Y is a direction parallel to plane REF and perpendicular to direction X, and Z is a direction perpendicular to directions X and Y.

A three-dimensional image of circuit Card corresponds to a cloud of an integral number M of points Q [symbol] ᵢ¹, where i is an integer varying from 1 to M. As an example, M is greater than several millions.

The exponent of Q [symbol] ¹ designates the position occupied by circuit Card relative to camera C and to projector P during the image acquisition. In the example illustrated in FIG. 5, circuit Card is motionless with respect to projector P and to camera C during the acquisition of images by camera C necessary for the determination of the three-dimensional image of a portion of circuit Card. This position is indicated by exponent “1”. A point Q [symbol] ¹(hᵢ) of the external surface of circuit Card is located in reference frame R_{REF} by coordinates (xᵢ, yᵢ, hᵢ). Coordinate hᵢ corresponds to the height of point Q [symbol] ¹ relative to plane REF. A method of determining a three-dimensional image of circuit Card comprises determining height hᵢ of each point Q [symbol] ¹.

Each point Q [symbol] ¹ has a corresponding point ^{C}q [symbol] ¹ in the image plane of camera C and a corresponding point ^{P}q [symbol] ¹ in the image plane of projector P. A reference frame R_{C}(O_{C}, X′, Y′, Z′) associated with camera C is considered, where O_{C} is the optical center of camera C, direction Z′ is parallel to the optical axis of camera C, and directions X′ and Y′ are perpendicular to each other and perpendicular to direction Z′. In reference frame R_{C}, to simplify the following description, it can approximately be considered that point ^{C}q [symbol] ¹ has coordinates (^{C}u [symbol] _{f}¹, ^{C}v [symbol] _{f}¹, f_{C}), where f_{C} is the focal distance of camera C. A reference frame R_{P}(O_{P}, X″, Y″, Z″) associated with projector P is considered, where O_{P} is the optical center of projector P, direction Z″ is parallel to the optical axis of projector P, and directions X″ and Y″ are perpendicular to each other and perpendicular to direction Z″. In reference frame R_{P}, to simplify the following description, it can be approximately considered that point ^{P}q [symbol] ¹ has coordinates (^{P}u [symbol] _{f}¹, ^{P}v [symbol] _{f}¹, f_{P}), where f_{P} is the focal distance of projector P.

Generally, calling P_{P} the projection matrix of projector P and P_{C} the projection matrix of camera C, one has the following equation system (1) for each point Q [symbol] ¹, noted in homogeneous coordinates:

$$\{ \begin{matrix}{}_{}^{P}{q}{}_{i}^{1} ( {h}_{i} ) \sim {P}_{P} {Q}_{i}^{1} ( {h}_{i} ) \\ {}_{}^{C}{q}{}_{i}^{1} ( {h}_{i} ) \sim {P}_{C} {Q}_{i}^{1} ( {h}_{i} )\end{matrix} \qquad ( 1 )$$

Each point Q [symbol] ¹ corresponds to the intersection of a line D_{C} associated with camera C and of a line D_{P} associated with projector P.

Each point ^{P}q [symbol] ¹ of the image projected by projector P is associated a phase φᵢ(hᵢ). Light intensity I₁^{C}(^{C}q [symbol] ¹(hᵢ)), measured by the pixel at point ^{C}q [symbol] ¹ of the image acquired by the camera and corresponding to point Q [symbol] ¹, follows relation (2) hereafter:

(^{C}q [symbol] ¹(hᵢ))=A(hᵢ)+B(hᵢ)cos φᵢ(hᵢ) (2)

where A(hᵢ) is the light intensity of the background at point Q [symbol] ¹ of the image, B(hᵢ) shows the amplitude between the minimum and maximum intensities at point Q [symbol] ¹ of the projected image.

In the example illustrated in FIG. 5, projector P successively projects N different images onto the circuit, where N is a natural number greater than 1, preferably greater than or equal to 4, for example, approximately 8.

For each projected image, a 2π/N phase shift is applied. As an example, grey levels G₁, G₂ of two projected images are illustrated in FIG. 5. Light intensity I_{d}^{C}(^{C}q [symbol] ¹(hᵢ)), measured by the pixel at point ^{C}q [symbol] ¹ for the d-th image acquired by the camera corresponding to point Q [symbol] ¹, follows relation (3) hereafter:

(^{C}q [symbol] ¹(hᵢ)=A+B cos(φ₁(hᵢ)+dα) (3)

where d is an integer which varies from 0 to N−1 and α is equal to 2π/N.

Vector I₁^{C}(hᵢ) is defined according to relation (4) hereafter:

$$( {h}_{i} ) = ( \begin{matrix}{I}_{0}^{C} ( {}_{}^{C}{q}{}_{i}^{0} ( {h}_{i} ) ) \\ ⋮ \\ {I}_{d}^{C} ( {}_{}^{C}{q}{}_{i}^{0} ( {h}_{i} ) ) \\ ⋮ \\ {I}_{N - 1}^{C} ( {}_{}^{C}{q}{}_{i}^{0} ( {h}_{i} ) )\end{matrix} ) = ( \begin{matrix}1 & 1 & 0 \\ ⋮ & ⋮ & ⋮ \\ 1 & cos ( d α ) & - sin ( d α ) \\ ⋮ & ⋮ & ⋮ \\ 1 & cos ( ( N - 1 ) α ) & - sin ( ( N - 1 ) α )\end{matrix} ) ( \begin{matrix}A \\ B cos {ϕ}_{i} ( {h}_{i} ) \\ B sin {ϕ}_{i} ( {h}_{i} )\end{matrix} ) \qquad ( 4 )$$

It is a linear equation system. It can be demonstrated that phase φᵢ(hᵢ) is given by relation (5) hereafter:

$$( {h}_{i} ) = arctan ( - \frac{{\sum }_{d = 0}^{N - 1} {I}_{d}^{C} sin ( p α )}{{\sum }_{d = 0}^{N - 1} {I}_{d}^{C} cos ( p α )} ) \qquad ( 5 )$$

In the example shown in FIG. 5, projector P and camera C are of telecentric type.

As an example, in the case where the following conditions are fulfilled:

the optical axes of projector P and of camera C are coplanar;

a row of the image projected by projector P is associated with a row of the image acquired by camera C, these rows being located in a plane parallel to direction X;

the projected images comprise straight fringes which extend, for example, perpendicularly to direction X and have a sinusoidally-varying amplitude;

lines D_{P} are perpendicular to plane REF and lines D_{C} form an angle θ with plane REF,

equation system (1) may be simplified according to the following equation system (6):

$$\{ \begin{matrix}{x}_{i}^{1} = {}_{}^{P}{u}{}_{i}^{1} \\ {h}_{i} = \frac{- 1}{tan θ} ( {x}_{i}^{1} - {x}_{iREF} )\end{matrix} \qquad ( 6 )$$

considering that point Q [symbol] REF¹ of coordinates ((x [symbol] _{iREF}¹, y [symbol] _{iREF}¹, 0) is the point of reference plane REF associated with point ^{C}q [symbol] ¹ of camera C.

In the image plane of projector P, abscissa ^{P}u [symbol] _{f}¹ of point ^{P}q [symbol] ¹ follows, for example, relation (7) hereafter:

=φαφᵢ(hᵢ)+b (7)

where a and b are real numbers, a being equal to p₀/2π with p₀ corresponding to the pitch of the sinusoidal fringes.

Based on relations (6) and (7), the following relation (8) is obtained:

γ(φ [symbol] ₁(Q [symbol] REF¹)−φ₁(Q [symbol] ¹)) (8)

where γ is equal to p₀/(2π tan θ) and φ₁(Q [symbol] REF¹) is equal to the phase at point Q [symbol] REF¹ of reference plane REF, that is, to the phase in the absence of the circuit.

In the case where the previously-mentioned conditions are not fulfilled, calculations are more complex. However, a literal expression of height hᵢ may be obtained.

FIG. 6 illustrates an example of a method of determining a three-dimensional image in the case where circuit Card to be inspected is motionless with respect to projector P and to camera C on acquisition of a plurality of successive images and in the case where camera C and projector P are of perspective type.

As compared with the previous case, equation system (1) cannot be simplified to provide equation system (6). However, it corresponds to a linear equation system for height hᵢ. It is thus possible to find a literal expression for height hᵢ.

FIG. 7 illustrates an example of a method of determining a three-dimensional image in the case where circuit Card to be inspected is mobile with respect to projector P and to camera C on acquisition of the N successive images and in the case where camera C and projector P are of telecentric type.

As an example, two positions of the circuit are shown in FIG. 7 for the acquisition of two successive images. Generally, at position “t”, t being an integer varying from 0 to N−1, point Q [symbol] which corresponds to point Q [symbol] after displacement of the circuit is obtained by relation (9) hereafter:

(hᵢ)=RₜQ [symbol] ¹(hᵢ)+Tₜ (9)

where Rₜ is a rotation matrix and Tₜ is a translation matrix, these matrixes being representative of the displacement of the circuit from position “1” to position “t”.

Projector P projects the same image onto the circuit on acquisition of the N successive images. This image comprises fringes which extend, for example, perpendicularly to direction X and having a sinusoidally-varying amplitude. Since the circuit is displaced with respect to the projector, light intensity I_{d}^{C}(^{C}q [symbol] ^{d}(hᵢ)) reflected by point Q [symbol] ^{d} is not the same as light intensity I_{B}^{C}(^{C}q [symbol] (hᵢ)) reflected by point Q [symbol] when d is different from s.

In the case where rotation matrix Rₜ corresponds to the identity matrix, that is, in the case of a translation with no rotation, vector Iᵢ^{C}(hᵢ) is then defined by relation (10) hereafter:

$$( {h}_{i} ) = ( \begin{matrix}{I}_{0}^{C} ( {}_{}^{C}{q}{}_{i}^{0} ( {h}_{i} ) ) \\ ⋮ \\ {I}_{d}^{C} ( {}_{}^{C}{q}{}_{i}^{d} ( {h}_{i} ) ) \\ ⋮ \\ {I}_{N - 1}^{C} ( {}_{}^{C}{q}{}_{i}^{N - 1} ( {h}_{i} ) )\end{matrix} ) \qquad ( 10 )$$

Since projector P is telecentric, the phase difference between intensity I_{d}^{C}(^{C}q [symbol] ^{d}(hᵢ)) reflected by point Q [symbol] ^{d} and intensity I_{d+1}^{C}(^{C}q [symbol] ^{d+1}(hᵢ)) reflected by point Q [symbol] ^{d+1} is the same whatever the considered point in the circuit. The relative displacement speed of the circuit with respect to the assembly comprising camera C and projector P may thus be selected so that the phase difference between intensities I_{d}^{C}(^{C}q [symbol] ^{d}(hᵢ)) and I_{d+1}^{C}(^{C}q [symbol] ^{d+1}(hᵢ)) corresponds to a 2π/N phase difference. In the image plane of projector P, abscissa ^{P}u [symbol] of point ^{P}q [symbol] ¹ thus follows previously-described relation (7).

Further, since camera C is also of telecentric type, the displacement of each point ^{C}q [symbol] ^{d} of the camera associated with point Q [symbol] ^{d} is the same whatever point Q [symbol] ^{d} of the circuit. In particular, this displacement is independent from height hᵢ.

The following relation (11) is thus obtained:

$$( {h}_{i} ) = ( \begin{matrix}{I}_{0}^{C} ( {}_{}^{C}{q}{}_{i}^{0} ( {h}_{i} ) ) \\ ⋮ \\ {I}_{d}^{C} ( {}_{}^{C}{q}{}_{i}^{d} ( {h}_{i} ) ) \\ ⋮ \\ {I}_{N - 1}^{C} ( {}_{}^{C}{q}{}_{i}^{N - 1} ( {h}_{i} ) )\end{matrix} ) = ( \begin{matrix}1 & 1 & 0 \\ ⋮ & ⋮ & ⋮ \\ 1 & cos ( d α ) & - sin ( d α ) \\ ⋮ & ⋮ & ⋮ \\ 1 & cos ( ( N - 1 ) α ) & - sin ( ( N - 1 ) α )\end{matrix} ) ( \begin{matrix}A \\ B cos {ϕ}_{i} ( {h}_{i} ) \\ B sin {ϕ}_{i} ( {h}_{i} )\end{matrix} ) \qquad ( 11 )$$

The expression of hᵢ according to relation (8) can thus be used.

In the three-dimensional image determination methods illustrated in FIGS. 5 to 7, height hᵢ is a solution of a linear equation so that an analytic expression of height hᵢ can be directly obtained.

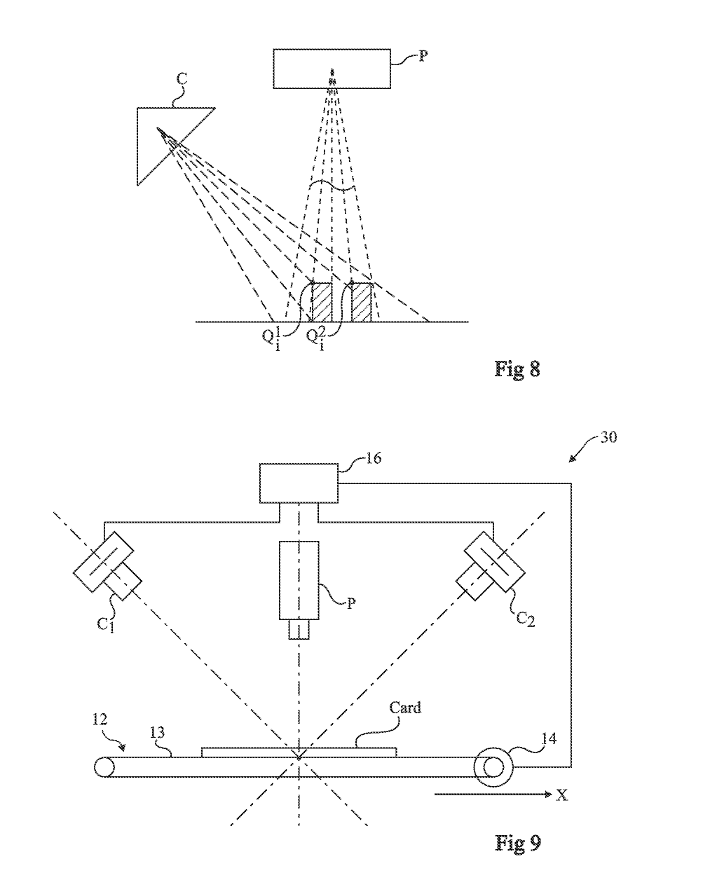

FIG. 8 illustrates an embodiment of a method of determining a three-dimensional image in the case where a relative displacement circuit Card to be inspected is performed with respect to projector P and to camera C on acquisition of a plurality of successive images and in the case where camera C and/or projector P are of perspective type.

The inventors have shown that, in this case, it is not possible to obtain an analytic expression of height hᵢ.

The inventors have shown that an analytic expression of height hᵢ cannot be obtained, particularly when the projector is of perspective type. Indeed, conversely to the example previously described in relation with FIG. 7, the phase difference between intensity I_{d}^{C}(^{C}q [symbol] ^{d}(hᵢ)) reflected by point Q [symbol] ^{d} and intensity I_{d+1}^{C}(^{C}q [symbol] ^{d+1}(hᵢ)) reflected by point Q [symbol] ^{d+1} is different according to the considered point. Indeed, the phase difference necessarily varies according to height hᵢ. It is thus not possible to select the relative displacement speed of the circuit with respect to the assembly comprising camera C and projector P so that the phase difference between intensity I_{d}^{C}(^{C}q [symbol] ^{d}(hᵢ)) reflected by point Q [symbol] ^{d} and intensity I_{d+1}^{C}(^{C}q [symbol] ^{d+1}(hᵢ)) reflected by point Q [symbol] ^{d+1} corresponds to a 2π/N phase difference for all points of the external surface.

Thereby, previous relation (3) is no longer valid but should be replaced with relation (12) hereafter:

(^{C}q [symbol] ¹(hᵢ))=A+B cos(φᵢ(hᵢ)+δφᵢ^{d}(hᵢ)) (12)

where δφᵢ^{d}(hᵢ) is a function of height hᵢ and of position d of point Q [symbol] ^{d}.

Further, the inventors have shown that an analytic expression of height hᵢ cannot be obtained when camera C is of perspective type. Indeed, when a relative displacement of circuit Card with respect to the assembly comprising camera C and projector P is performed between the acquisition of two images, the displacement of the pixel at point ^{C}q [symbol] ^{d} of the camera associated with point Q [symbol] ^{d} is not the same for all points Q [symbol] ^{d} of the circuit and, in particular, depends on height hᵢ of point Q [symbol] ^{d}.

Thereby, as soon as camera C or projector P is of perspective type and a relative displacement of circuit Card with respect to camera C and to projector P is performed on acquisition of the images, the previously-described three-dimensional image determination algorithms cannot be applied.

The inventors have however determined that the three-dimensional image of the circuit could be obtained by determining a cost function Cost which particularly depends on height hᵢ. The desired height hᵢ then is that for which cost function Cost reaches a minimum value according to the following relation (13):

=argminₕCostᵢ(h) (13)

The cost function may be based on the comparison between signals obtained from the image acquired by the camera and the image displayed by the projector, the images acquired by more than one camera and the image displayed by the projector, or the images acquired by at least two cameras or more. The signal may correspond to a pseudo-phase or to the light intensity.

According to an embodiment, the cost function is determined by comparing the phase of the projected image with at least one phase estimate determined based on the image acquired by a camera or by comparing phase estimates determined based on the images acquired by at least two cameras. Expression (13) then amounts to minimizing a phase difference.

Previously-described relation (11) becomes relation (14) hereafter, by using relation (12):

$$( {h}_{i} ) = \underbrace{( \begin{matrix}1 & cos ( {δϕ}_{i}^{0} ( {h}_{i} ) ) & - sin ( {δϕ}_{i}^{0} ( {h}_{i} ) ) \\ ⋮ & ⋮ & ⋮ \\ 1 & cos ( {δϕ}_{i}^{d} ( {h}_{i} ) ) & - sin ( {δϕ}_{i}^{d} ( {h}_{i} ) ) \\ ⋮ & ⋮ & ⋮ \\ 1 & cos ( {δϕ}_{i}^{N - 1} ( {h}_{i} ) ) & - sin ( {δϕ}_{i}^{N - 1} ( {h}_{i} ) )\end{matrix} )}_{{Δ}_{i} ( {h}_{i} )} \underbrace{( \begin{matrix}A \\ B cos {ϕ}_{i}^{0} ( {h}_{i} ) \\ B sin {ϕ}_{i}^{0} ( {h}_{i} )\end{matrix} )}_{{X}_{i}^{C} ( {h}_{i} )} \qquad ( 14 )$$

An estimated vector \hat{X}ᵢ^{C} (hᵢ), having coordinates (\hat{γ}ᵢ^{C}(hᵢ),\hat{β}ᵢ^{C}(hᵢ))^{T} is determined, which corresponds to an estimate of vector X₁^{C}(hᵢ) and is provided by the following relation (15):

(hᵢ)=(Δᵢ(hᵢ))⁺I₁^{C}(hᵢ) (15)

Variables Ĉᵢ^{C}(hᵢ) and ŝᵢ^{C}(hᵢ) given by the following relation (16) are further used:

$$= [ \begin{matrix}{\hat{α}}_{i}^{C} ( {h}_{i} ) \\ {\hat{β}}_{i}^{C} ( {h}_{i} )\end{matrix} ] / ‖ [ \begin{matrix}{\hat{α}}_{i}^{C} ( {h}_{i} ) \\ {\hat{β}}_{i}^{C} ( {h}_{i} )\end{matrix} ] ‖ \qquad ( 16 )$$

In the embodiment illustrated in FIG. 8, comprising a camera C and a projector P, for a given height hᵢ and position d, phase φᵢ^{d}(hᵢ) may be determined based on the equations of operation of projector P. According to the present embodiment, cost function Cost₁ is given by the following relation (17):

$${Cost}_{1} ( {h}_{i} ) = {‖ [ \begin{matrix}{\hat{c}}_{i}^{C} ( {h}_{i} ) \\ {\hat{s}}_{i}^{C} ( {h}_{i} )\end{matrix} ] - [ \begin{matrix}cos ( {ϕ}_{i}^{0} {ϕ}_{i} ( {h}_{i} ) ) \\ sin ( {ϕ}_{i}^{0} {ϕ}_{i} ( {h}_{i} ) )\end{matrix} ] ‖}^{2} \qquad ( 17 )$$

FIG. 9 shows another embodiment where optical inspection system 30 comprises at least two cameras C₁ and C₂. Projector P and/or cameras C₁ and C₂ are of perspective type.

According to an embodiment, cost function Cost₂ for system 30 is determined according to the following relation (18):

$$( {h}_{i} ) = {‖ [ \begin{matrix}{\hat{c}}_{i}^{{C}_{1}} ( {h}_{i} ) \\ {\hat{s}}_{i}^{{C}_{1}} ( {h}_{i} )\end{matrix} ] - [ \begin{matrix}{\hat{c}}_{i}^{{C}_{2}} ( {h}_{i} ) \\ {\hat{s}}_{i}^{{C}_{2}} ( {h}_{i} )\end{matrix} ] ‖}^{2} \qquad ( 18 )$$

According to another embodiment, optical inspection system 30 comprises G cameras C₁, C₂, . . . , C_{G}, where G is an integer greater than or equal to 3 and cost function Cost₃ is given by the following relation (19):

$$( {h}_{i} ) = {\sum }_{k = 1}^{k = G} {‖ [ \begin{matrix}{\hat{c}}_{i}^{k} ( {h}_{i} ) \\ {\hat{s}}_{i}^{k} ( {h}_{i} )\end{matrix} ] - \frac{1}{G} {\sum }_{l = 1}^{l = G} [ \begin{matrix}{\hat{c}}_{i}^{l} ( {h}_{i} ) \\ {\hat{s}}_{i}^{l} ( {h}_{i} )\end{matrix} ] ‖}^{2} \qquad ( 19 )$$

According to another embodiment, optical inspection system 30 comprises G cameras C₁, C₂, . . . , C_{G}, where G is an integer greater than or equal to 3 and cost function Cost₄ is given by the following relation (20):

$$( {h}_{i} ) = {\sum }_{k = 1}^{k = G} {‖ [ \begin{matrix}{\hat{c}}_{i}^{k} ( {h}_{i} ) \\ {\hat{s}}_{i}^{k} ( {h}_{i} )\end{matrix} ] - [ \begin{matrix}cos ( {ϕ}_{i}^{0} {ϕ}_{i} ( {h}_{i} ) ) \\ sin ( {ϕ}_{i}^{0} {ϕ}_{i} ( {h}_{i} ) )\end{matrix} ] ‖}^{2} \qquad ( 20 )$$

According to an embodiment where inspection system 30 comprises at least two cameras C₁, C₂, the cost function is determined by directly comparing the images provided by at least two different cameras. Expression (13) then amounts to minimizing a light intensity difference.

As an example, cost function Cost₅ is given by the following relation (21):

(hᵢ)=∥Iᵢ^{C}^{₁}(hᵢ)−Iᵢ^{C}^{₂}(hᵢ)∥² (21)

According to another embodiment, optical inspection system 30 comprises G cameras C₁, C₂, . . . , C_{G} and cost function Cost₆ is given by the following relation (22):

$$( {h}_{i} ) = {\sum }_{k = 1}^{k = G} {‖ {I}_{l}^{k} ( {h}_{i} ) - \frac{1}{G} {\sum }_{l = 1}^{l = G} {I}_{i}^{l} ( {h}_{i} ) ‖}^{2} \qquad ( 22 )$$

The previously-described cost functions may be implemented in the case previously described in relation with FIG. 7, where camera C and projector P are of telecentric type, when rotation matrix Rₜ is different from the identity matrix.

Specific embodiments have been described. Various alterations and modifications will occur to those skilled in the art. In particular, although in the embodiments, the projector is arranged vertically in line with the electronic circuit and the cameras are arranged on either side of the projector, cameras may be arranged vertically in line with the circuit to be inspected and projectors may be arranged on either side of the camera. Further, although an optical inspection system has been described for the inspection of electronic circuits, it should be clear that the optical inspection system may be used for the inspection of other objects.

1. A method of determining three-dimensional images of an object, comprising:
projecting a display onto the object with a projector;
acquiring a plurality of two-dimensional images of the object with at least one first image sensor, a relative displacement of the object with respect to the assembly comprising the projector and the image sensor being performed during the image acquisitions, the duration between two successive image acquisitions being in the range from 10 ms to 250 ms, the speed of the relative displacement being in the range from 20 mm/s to 200 mm/s; and
determining the height of each point of the object as corresponding to an extremum of a function obtained from the acquired bidimensional images.

2. The method of claim 1, wherein the projector and/or the first image sensor are of perspective type.

3. The method of claim 1, wherein the projected display is identical on acquisition of each two-dimensional image.

4. The method of claim 1, wherein the display comprises fringes.

5. The method claim 1, wherein a relative displacement of the object with respect to the assembly comprising the projector and the image sensor is performed on acquisition of at least one of the two-dimensional images.

6. The method of claim 5, wherein a relative displacement of the object with respect to the assembly comprising the projector and the image sensor is performed on acquisition of each two-dimensional image.

7. The method claim 1, wherein the relative displacement is accelerated between the acquisitions of the two images of at least one pair of successive two-dimensional images.

8. The method claim 1, wherein the speed of the relative displacement is constant to within 10%.

9. The method claim 1, comprising acquiring a plurality of two-dimensional images of the object with at least one second image sensor, the height of each point of the object corresponding to an extremum of a function obtained from the images acquired by the first and second image sensors.

10. A system for determining three-dimensional images of an object, comprising:
a projector capable of projecting a display onto the object;
a first image sensor capable of acquiring a plurality of two-dimensional images of the object, the duration between two successive image acquisitions being in the range from 10 ms to 250 ms;
a conveyor capable of performing a relative displacement of the object with respect to the assembly comprising the projector and the first image sensor on successive acquisitions of two-dimensional images, the relative displacement speed being in the range from 20 mm/s to 200 mm/s; and
processing means capable of determining the height of each point of the object as corresponding to an extremum of a function obtained from the acquired bidimensional images.

11. The system of claim 10, wherein the projector and/or the first image sensor are of perspective type.
